(19) United States
(12) Patent Application Publication
(10) Pub. No.: US 2012/0078746 A1
(43) Pub. Date: Mar. 29, 2012

(54) SYSTEMS AND METHODS FOR DISCOVERY OF RELATED INTERACTABLE ITEMS IN A MOBILE STORE ENVIRONMENT

(76) Inventors: Giuliano MACIOCCI, Duxford (GB); Peter ANDIC, Stevenage (GB); Janet L. DOBSON, Linton (GB)

(21) Appl. No.: 13/229,755

(22) Filed: Sep. 11, 2011

Related U.S. Application Data
(60) Provisional application No. 61/387,460, filed on Sep. 28, 2010.

(51) Int. Cl. G06Q 30/06

(52) U.S. Cl. 705/26.7

(57) ABSTRACT

Methods and apparatus for providing interactable item suggestions may include selecting a seed interactable item and determining a first set of one or more interactable items related to the seed interactable item based on one or more data sources. The methods and apparatus may further include generating a graphical presentation with a first set of interactable items with the seed interactable item and the one or more related interactable items. The methods and apparatus may also include generating a new graphical presentation of a second set of one or more interactable items related to a selected interactable item.

### CLAIM OF PRIORITY UNDER 35 U.S.C. §119

The present application for patent claims priority to Provisional Application No. 61/387,460 entitled “System and Methods for Discovery of Related Content in a Mobile Application Store Environment” filed Sep. 28, 2010, and assigned to the assignee hereof and hereby expressly incorporated by reference herein.

### BACKGROUND

This application relates generally to mobile application stores, and more particularly to deriving content recommendations from mobile application store offerings.

Portable electronic devices today, including mobile phones, personal digital assistants (PDAs), smart phones, etc., are used for much more than simple phone calls, text messages, and emails. Today's devices enable users to access and/or download various applications, such as games, music, and/or other applications. Typically, a user purchases applications from an on-line application store.

The typical application store provides long lists of categorized content from which a user to select. It would be desirable to have a mechanism for tailoring content recommendations to a particular user. In addition, it would be desirable to have a method of retracing a user's navigation journey through content.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to some aspects, a method for providing interactable item suggestions may include determining a seed interactable item. The method may also include determining one or more interactable items related to the seed interactable item based on one or more data sources. The method may further include generating graphical presentation data that includes a first set of the one or more interactable items and the seed interactable item. In addition, the method may include receiving a selection of one interactable item from the first set and storing the selection. My method may also include generating new graphical presentation data that includes a second set of at least one interactable item related to the selection. In such aspect, the new graphical presentation data includes a link from the seed interactable item to the selection.

According to some aspects at least one processor configured to present interactable item suggestions is provided. The at least one processor may include a first module for determining a seed interactable item. The processor may also include a second module for determining one or more interactable items related to the seed interactable item based on one or more data sources. The processor may further include a third module for generating graphical presentation data that comprises a first set of the one or more interactable items and the seed interactable item. In addition, the processor may include a fourth module for receiving a selection of one interactable item from the first set and storing the selection. Moreover, the processor may include a fifth module for generating new graphical presentation data that includes a second set of at least one interactable item related to the selection. In such aspect, the new graphical presentation includes a link from the seed interactable item to the selection.

Yet another aspect relates to a computer program product. The computer program product may include a computer-readable medium including at least one instruction for causing a computer to determine a seed interactable item. The computer-readable medium may additionally include at least one instruction for causing the computer to determine one or more interactable items related to the seed interactable item based on one or more data sources. The computer-readable medium may also include at least one instruction for causing the computer to generate graphical presentation data that includes a first set of interactable items and the seed interactable item. The computer-readable medium may further include at least one instruction for causing the computer to receive a selection of one interactable item from the first set and storing the selection. The computer-readable medium may also include at least one instruction for causing the computer to generate new graphical presentation data comprising a second set of at least one interactable item related to the selection. In such aspect, the new graphical presentation includes a link from the seed interactable item to the selection.

Another aspect relates to an apparatus that may include means for determining a seed interactable item. The apparatus may also include means for determining one or more interactable items related to the seed interactable item based on one or more data sources. Additionally, the apparatus may include means for generating graphical presentation data that includes a first set of the one or more interactable items and the seed interactable item. The apparatus may also include means for receiving a selection of one interactable item from the first set and storing the selection. The apparatus may further include means for generating new graphical presentation data that includes a second set of at least one interactable item related to the selection. In this aspect, the new graphical presentation includes a link from the seed interactable item to the selection.

Another aspect relates to an apparatus that may include an interactable item recommendation engine configured to determine a seed interactable item and determine one or more interactable items related to the seed interactable item based on one or more data sources. In addition, the apparatus may include a user interface management module configured to generate graphical presentation data that includes a first set of the one or more interactable items and the seed interactable item. The user interface module is further configures to receive a selection of one interactable item from the first set and store the selection. The user interface module is further configured to generate new graphical presentation data that includes a second set of at least one interactable item related to the selection. In this aspect the interactable item recommendation engine is further configured to determine the second set, and the new graphical presentation includes a link from the seed interactable item to the selection.

Still another aspect relates to a method for presenting interactable item suggestions. The method may include receiving, at a wireless device, graphical presentation data that includes a first set of interactable items comprising a seed interactable item and one or more interactable items related to the seed interactable item. In this aspect, the seed interactable item is determined based upon user data associated with the wireless device. The method may also include presenting the graphical presentation data. In addition, the method may include receiving a selection of one of one interactable item from the first set and forwarding the selection for processing. The method may further include receiving new graphical presentation data that includes a second set of at least one interactable item related to the selection. The method may further include presenting the new graphical presentation data. In such aspect, the new graphical presentation data includes a link from the seed interactable item to the selection.

Yet another aspect relates to at least one processor configured to present interactable item suggestions. The processor may include a first module for receiving, at a wireless device, graphical presentation data that includes a first set of interactable items including a seed interactable item and one or more interactable items related to the seed interactable item. In this aspect, the seed interactable item is determined based upon user data associated with the wireless device. The processor may also include a second module for presenting the graphical presentation data. The processor may also include a third module for receiving a selection of one interactable item from the first set of interactable items and forwarding the selection for processing. The processor may additionally include a fourth module for receiving new graphical presentation data that includes a second set of at least one interactable item related to the selection. Moreover, the processor may include a fifth module for presenting the new graphical presentation data. In this aspect, the new graphical presentation data includes a link from the seed interactable item to the selection.

Another aspect relates to a computer program product. The computer program product may include a computer-readable medium including at least one instruction for causing a computer to receive, at a wireless device, graphical presentation data that includes a first set of interactable items including a seed interactable item and one or more interactable items related to the seed interactable item. In this aspect, the seed interactable item is determined based upon user data associated with the wireless device. The computer-readable medium may also include at least one instruction for causing the computer to present the graphical presentation data. In addition, the computer-readable medium may also include at least one instruction for causing the computer to receive a selection of one interactable item from the first set and forwarding the selection for processing. The computer-readable medium may further include at least one instruction for causing the computer to receive new graphical presentation data that includes a second set of at lest one interactable item related to the selection. Additionally, the computer-readable medium may include at least one instruction for causing the computer to present the new graphical presentation data. In this aspect, the new graphical presentation data includes a link from the seed interactable item to the selection.

Yet another aspect relates to an apparatus that may include means for receiving, at a wireless device, graphical presentation data that includes a first set of interactable items including a seed interactable item and one or more interactable items related to the seed interactable item. In this aspect, the seed interactable item is determined based upon user data associated with the wireless device. The apparatus may also include means for presenting the graphical presentation data. Further, the apparatus may include means for receiving a selection of one interactable item from the first set and forwarding the selection for processing. The apparatus may also include means for receiving new graphical presentation data that includes a second set of at least one interactable item related to the selection. In addition, the apparatus may include means for presenting the new graphical presentation data. In this aspect, the new graphical presentation data includes a link from the seed interactable item to the selection.

Still another aspect relates to a wireless device for presenting interactable item suggestions. The wireless device may include a presenting component configured to receive graphical presentation data that includes a first set of interactable items including a seed interactable item and one or more interactable items related to the seed interactable item. In this aspect, the seed interactable item is determined based upon user data associated with the wireless device. The presenting component is further configured to present the graphical presentation data. The wireless device may also include a navigation component configured to receive a selection of one interactable item from the first set and forward the selection for processing. In addition, the presenting component may further be configured to receive new graphical presentation data that includes a second set of at lest one interactable item related to the selection, and present the new graphical presentation data. In this aspect, the new graphical presentation data includes a link from the seed interactable item to the selection.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is an illustration of a connectivity system in accordance with an aspect;

FIG. 2 is an illustration of an interactable item recommendation engine operable within the connectivity system in accordance with another aspect;

FIGS. 3-8 illustrate exemplary graphical user interfaces, according to yet another aspect;

FIG. 9 is an example method flow for generating interactable item recommendations, according to another aspect;

FIG. 10 is an example method flow for presenting interactable item recommendations, according to yet another aspect;

FIG. 11 is an example wireless device operable within the connectivity system in accordance with an aspect;

FIG. 12 is an example server device operable within the connectivity system in accordance with yet another aspect;

FIG. 13 illustrates a system for generating interactable item recommendations, in accordance with various described aspects; and

FIG. 14 illustrates a system for presenting interactable item recommendations, in accordance with another aspect.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

In the subject disclosure, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

The described aspects relate to methods and apparatus for recommending interactable items, such as content (e.g., applications) and/or services, to one or more users of wireless devices. For example, the recommended interactable items may be presented to one or more users of wireless devices to download, purchase, access, view, and/or share with other users of wireless devices. The described aspects may determine relationships between interactable items and dynamically generate the recommended interactable items based upon the determined relationships.

The described aspects also relate to methods and apparatus for presenting the recommended interactable items by providing links between the recommended interactable items and creating a trail of recommended interactable items. For example, one or more users of wireless devices may journey through the recommended interactable items (e.g., applications and/or services) by following the links between the recommended interactable items (e.g., applications and/or services).

The described aspects further relate to methods and apparatus for transitioning through user interfaces to present the selected recommended interactable items. For example, when a user selects a recommended interactable item to view, the user interface may zoom in and/or out to present the selected interactable item to view. In addition, the user interfaces may transition as a user moves through the links between the recommended interactable items to present the newly selected interactable items and the interactable items related to the selected interactable items.

As used in this disclosure, the term “interactable item” may relate to “content” or a “content item” or to a “service”. As used herein, the term “content” or “content item” includes, at least, one or more of any type of application, multimedia file, image file, executable program, web page, script, document, presentation, message, data, meta-data, music, video, electronic book, ringtone, wallpaper, an electronic representation of a physical item, or any other type of media or information that may be rendered, processed, or executed on a device.

Also, the term “service” includes, at least, providing of an action or an accommodation, including in electronic or non-electronic form. For example, in one aspect, a service may include providing access, such as access to a network server. For instance, in one non-limiting aspect, a use case of providing access to a network server may include a scenario where a user is a player in a game, and access is provided to a network server to enable the user to participate in a network-based multi-player service for the game provided by the network server.

In one aspect, which should not be construed as limiting, the interactable item will be described in the context of an illustrative example relating to displaying application information. It should be understood that instead of, or in addition to, applications, the present aspects may apply to other types of content, or to services, or to a combination of content and services.

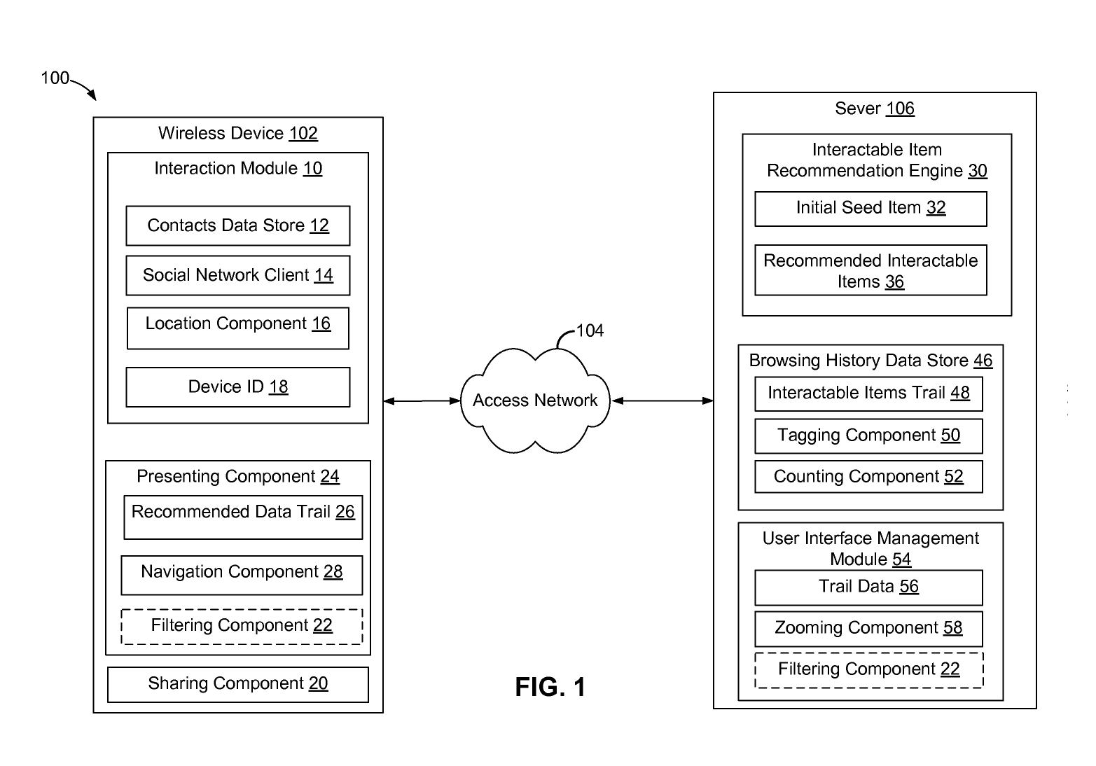

Referring now to FIG. 1, illustrated is an example connectivity system 100 for implementing various aspects of the subject disclosure. Wireless device 102 is communicatively coupled to server 106 via an access network 104, such as the Internet. Wireless device 102 may include any mobile or portable computing or communications device, such as a cellular device, that may connect to an access network 104. Wireless device 102 may be, for example, a cellular telephone, a navigation system, a computing device, a camera, a PDA, a music device, a gaming device or a handheld device having wireless connection capability, among other devices. Wireless device 102 may also comprise a wired device such as personal computer. Server/computing device 106 may include any mobile or fixed computing device connected to a network. Sever/computing device 106 may include, but is not limited to, a computing device, a server, a cellular telephone, a camera, a PDA, a music device, a gaming device, a navigation system, or a handheld device having wireless connection capability, among other devices. Furthermore, access network 104 may provide one or more types of communication connections, such as any type of wireless airlink, to wireless device 102 and server 106.

Wireless device 102 may include an interaction module 10 for enabling a user of wireless device 102 to interact with interactable item recommendation engine 30 (server 106). For example, interaction module 10 may facilitate collection of user data needed by interactable item recommendation engine 30 to recommend interactable items to the user of wireless device 102. User data may include, but is not limited to, social network registration information associated with one or more social networks, contact lists, location information, and/or interactable items that have been previously viewed, downloaded, purchased, accessed, and/or shared, among other user data.

In an aspect, interaction module 10 may include a contacts data store 12 operable to store interactable item information relating to one or more contacts associated with wireless device 102. Contacts may include, but are not limited to, friends, family, co-workers, social network friends, among other contacts. Interaction module 10 may, for example, forward the contact information, such as a contact's name and/or a contact's address from contact data store 12 to interactable item recommendation engine 30 for use in recommending interactable items to the user of wireless device 102. In an aspect, interactable item recommendation engine 30 may recommend interactable items that have been downloaded and/or purchased by one or more contacts associated with the user of wireless device 102.

Interaction module 10 may further include one or more social network clients 14 which may send social network information associated with one or more social network services associated with wireless device 102 to interactable item recommendation engine 30. Social network information may include, but is not limited to, authentication information (e.g., usernames and/or passwords) for the one or more social network services associated with the user of wireless device 102 and/or social network contact information from the one or more social network services. In an aspect, interactable item recommendation engine 30 may use the received social network information to establish one or more communication sessions with the one or more social network services associated with wireless device 102. In another aspect, interactable item recommendation engine 30 may use the received contact information from the one or more social networking services for recommending interactable items to the user. For example, interactable item recommendation engine 30 may recommend interactable items that have been downloaded and/or purchased by one or more contacts associated with the one or more social networking services.

Interaction module 10 may also include a location component 16 operable for determining device location information. Location component 16 may be a position/location component (e.g. a Global Positioning System (GPS) module, or a terrestrial or cellular network based location module) on the wireless device, indicating the geographic coordinates where the data content was captured, or a network identifier corresponding to a network component having a location that can be identified. Location component 16 may forward location information to interactable item recommendation engine 30 for use with recommending interactable items. For example, interactable item recommendation engine 30 may use the location of wireless device 102 in recommending interactable items that were purchased and/or downloaded by other users in the location.

In addition, interaction module 10 may also include a device identifier 18 operable for generating a unique identification for the wireless device 102. In an aspect, device identifier 18 may be associated with the collected user data.

Server 106 may comprise an interactable item recommendation engine 30 configured to determine relationships among interactable items 34 and to generate recommended interactable items 36 for presenting to a user of a wireless device based upon one or more algorithms. According to some aspects, interactable item recommendation engine 30 varies the types of data used in making a recommendation. So, for example, one recommended interactable item may be based on a social network friend's usage, another on an editorial or marketing choice by the owners of an interactable item store, another based on the number of downloads by the general public, etc. Each time a user selects an interactable item, interactable item recommendation engine 30 may perform a new relationship calculation to determine additional interactable item to be presented.

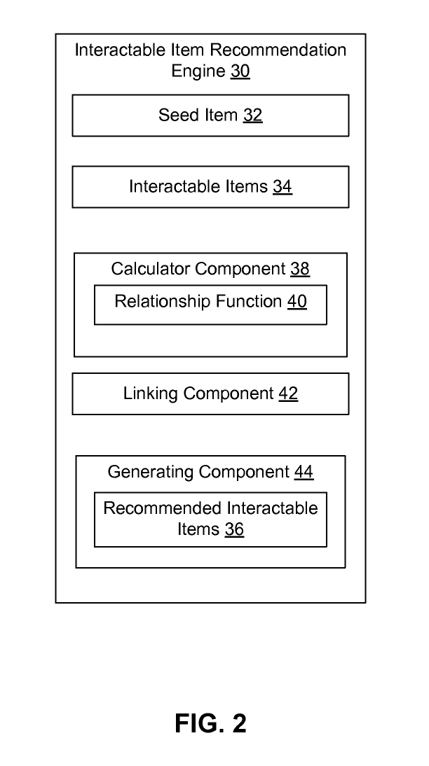

Referring now to FIG. 2, illustrated is an example interactable item recommendation engine 30 in accordance with an aspect. Interactable item recommendation engine 30 may be configured to start with a seed item 32 for presenting to the user. This seed item 32 selection may be based, for example, on a user's previous downloads, a user's social network friends download history, or it could be an editorial choice make for marketing reasons or chosen by the owners of the application store. Other factors may also be considered in determining the seed item selection. Interactable item recommendation engine 30 may choose a plurality of interactable items 34 that are related to the seed item 32 to present to the user using one or more of the factors described below. For example, the related interactable items may include, but are not limited to, applications, such as social media applications, games, weather applications, news applications, sports applications, or shopping applications, among other applications, and services such as, but not limited to, playing games, viewing television programs, streaming video, or using social media applications, among other services.

Interactable item recommendation engine 30 may have a calculator component 38 that may interface with a data store of interactable items 34 to calculate a relationship between interactable items 34 and seed item 32 according to a relationship function 40. Relationship function 40 may include, but is not limited to, an algorithm, rule, fuzzy logic, or any other mechanism for calculating relationships between interactable items. For example, relationships may be based upon various data sources, such as but not limited to, metadata input by an interactable item's developer, downloads performed by others (e.g., whether multiple users have downloaded a common group of interactable items), social network data, genre data, and/or location data, among other data sources. By using various data sources in determining the relationships, an eclectic group of related interactable items may be generated. In addition, by using various data sources in determining the relationships, the generated group of related interactable items may not be based upon a hierarchical and/or nested relationship because the relationships may be based upon, for example, a common friend and/or location.

Interactable item recommendation engine 30 may also include a linking component 42 operable to link the seed item 32 with the one or more interactable items 34 that calculator component 38 determined to have one or more relationships with seed item 32, and thus, creating a trail connecting the related interactable items. By linking the related interactable items to the seed item 32, a user may be able to access the one or more related interactable items by selecting the link between the interactable items.

In addition, interactable item recommendation engine 30 may further include a generating component 44 operable to generate one or more recommended interactable items 36. Recommended interactable items 36 may include, but are not limited to, interactable items linked together by linking component 42, e.g., the seed interactable item 32 and the one or more interactable items 34 determined to have a relationship with seed interactable item 32. In an aspect, generating component 44 may place relative weights on the various data sources for determining whether interactable items should be recommended to a user. More weight may be given, for example, to interactable items 34 downloaded by a user's social network friends and/or contacts relative to weights associated with interactable items 34 downloaded by a general user. For example, because of a relative weighting that gives more influence to people associated with the user, an interactable item 34 downloaded by a single one of a user's social network friends may have the same ranking as an interactable item 34 that has been downloaded by 100 general users.

Referring back to FIG. 1, server 106 may further include a browsing history data store 46 configured to maintain a user's browsing history through an interactable items trail 48, which may include various presented interactable items from recommended interactable items 36. Browsing history data store 46 may include a tagging component 50 which may identify and/or mark trail interactable items. For example, if a user selects a game application to review at a later period of time, tagging component 50 may mark the game application so that the user may easily select the game application at the later period of time to review. In addition, the user may add one or more interactable items to a favorite lists by using tagging component 50 to mark the one or more interactable items as a favorite. Browsing history data store 46 may also include a counting component 52 which may have a counter keeping a total count for each of the one or more interactable items accessed by one or more users of wireless. For example, if a game application has been purchased 200 times, the counter for the particular game application may equal 200. In another aspect, the counting component 52 may be operable to keep scores for one or more interactable items.

In addition, server 106 may include a user interface management module 54. User interface management module 54 may be configured to generate a plurality of user interface screens that are presented to a user with the one or more recommended interactable items 36. The user interface management module 54 may also control switching among the various displays. For example, user interface management module 54 may be configured to accept input to switch from viewing the details associated with a particular interactable item, to viewing trail data 56, e.g., a breadcrumb trail, of previously viewed interactable items linked together. The user interface management module 54 may, for example, display the trail data 56 as a map that can be panned up, down, left, right, etc., enabling the user to view their journey through the various interactable items. A user can select a previously selected item and drop back to a view showing the selected item and the related items that were previously presented. The user interface management module 54 may further be configured to have a zoom component 58 operable for displaying a subset of information and/or detailed information of the selected item. For example, zoom component 58 may display detailed information about a selected interactable item such as, for example, a description of the interactable item, its costs, its popularity among a user's social network friends or within the user's geographic location, etc.

The interactable items 34 may be presented via a series of display screens, wherein each interactable item presented on each screen is related to the others. Interactable items may include, for example, one or more of any type of application, multimedia file, image file, executable program, web page, script, document, presentation, message, music, video, electronic book, ringtone, wallpaper, an electronic representation of a physical item, or any other type of media or information that may be rendered, processed, or executed on a device. In addition, interactable items may include, for example, one or more of any type of service, but not limited to, playing games, viewing television programs, streaming video, or using social media applications, among other services.

Referring back to wireless device 102, wireless device 102 may have a presenting component 24 operable to receive and present the recommended data trail 26. In addition, presenting component 24 may have a navigation component 28 operable to track a user's movements through the recommended data trail 26. For example, navigation component 28 may receive inputs from other wireless device and server components, such as, but not limited to, a memory or database, a clock, a position location module, a camera, a microphone, a wired or wireless communication interface, a keypad, or a touch sensitive display, among others sources of inputs. Accordingly, a user may view and interact with the navigation component 28 using various gestures, such as, for example, dragging and pinching. These gestures may be used to navigate from one screen to another. Touch gestures may also be used as an input method.

Thus, as a user moves through the recommended data trail 26, navigation component 28 may send information defining the user's location in the recommended data trail 26 to user interface management module 54 (server 106). The location may include, but is not limited to, a selected interactable item, a selected link, and descriptions of a selected interactable item, among other trail locations. User interface management module 54 may receive the current location and send updated recommended trail data 56 to presenting component 24 based upon the received location.

Presenting component 24 may optionally include a filter component 22 operable to filter the interactable items presented from recommended data trail 26. For example, filter component 22 may receive input to filter the interactable items based upon, but not limited to, interactable item genre, interactable item ratings, content type, regional controls, interactable item prices, interactable item ratings, and/or based on the purchasing profile of users who have purchased similar interactable item, among other filters. For example, the user of wireless device may provide input for filtering the interactable items displayed based upon, for example, the interactable items ratings. In another optional aspect, user interface management module 54 may also include filter component 22 operable to filter interactable items in trail data 56.

Wireless device 102 may further include a sharing component 20 operable to share one or more recommended data trails 26 and/or recommended interactable items to one or more other users of wireless device. In an aspect, sharing component 20 may interface with contacts data store 12 and share one or more recommended data trails 26 with one or more contacts stored in contacts data store 12. In another aspect, sharing component 20 may interface with social network client 14 and share one or more recommended data trails 26 via one or more social network services associated with the user of wireless device 102. For example, sharing component 20 may use social network client 14 to send a message, such as an e-mail message with the recommended data trails 26 to one or more social network contacts.

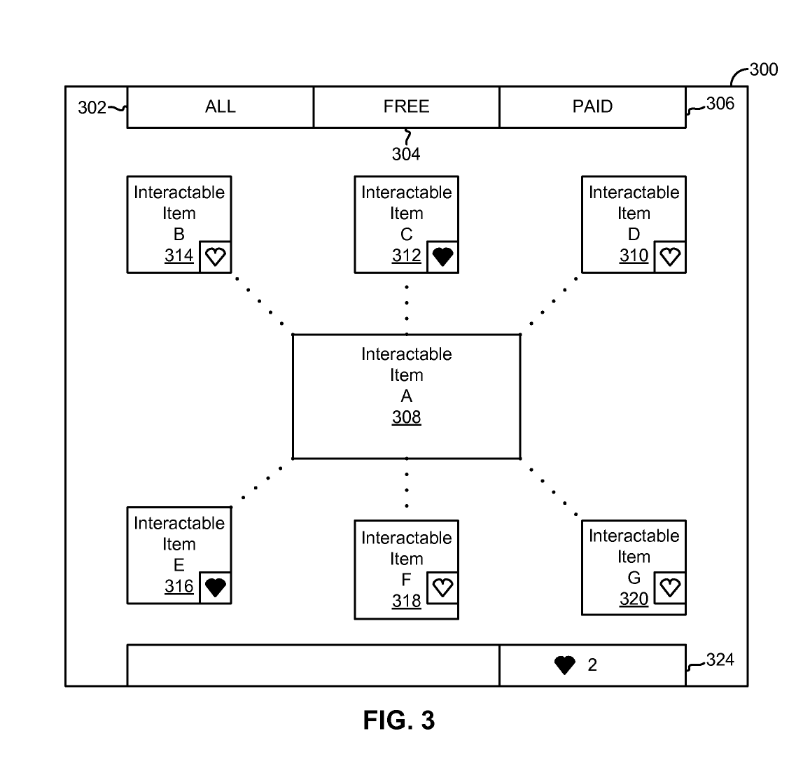

Referring now to FIG. 3, illustrated is an example main user interface 300 that may be presented to a user connecting to server 106. The main user interface 300 may include one or more filter tabs enabling a user to filter the interactable item presented. For example, the main user interface 300 may include a filter tab 302 for presenting all types of interactable items, a filter tab 304 for presenting only those interactable items that are free, and a filter tab 306 for presenting only those interactable items that are available for a fee. Other filter tabs may also be included.

As shown in the center of FIG. 3, icons representing seven interactable items are presented. It should be noted that the depiction of seven interactable items is merely exemplary. Any number of interactable items may be presented. Interactable item A 308 is shown surrounded by interactable items B-G 314-320. Interactable item A 308 may be an initial seed interactable item. Each of interactable items B-G 314-320 have been determined by the interactable item recommendation engine 30 depicted in FIG. 1 to be related to interactable item A 308. For each interactable item, the full item name and price may be displayed. In addition, each item displayed may include a favorite icon, allowing the user to add it to a favorites list. In FIG. 3, the favorite icon is depicted as a heart that is shaded upon selection. However, any other type of icon or indicator may be used to add an item to the favorites list. As shown at the bottom of interface 300, a footer may be included having a favorites counter 324. The favorites counter 324 keeps track of the number of interactable items that have been added to user's favorites list as the user navigates through the recommended interactable items.

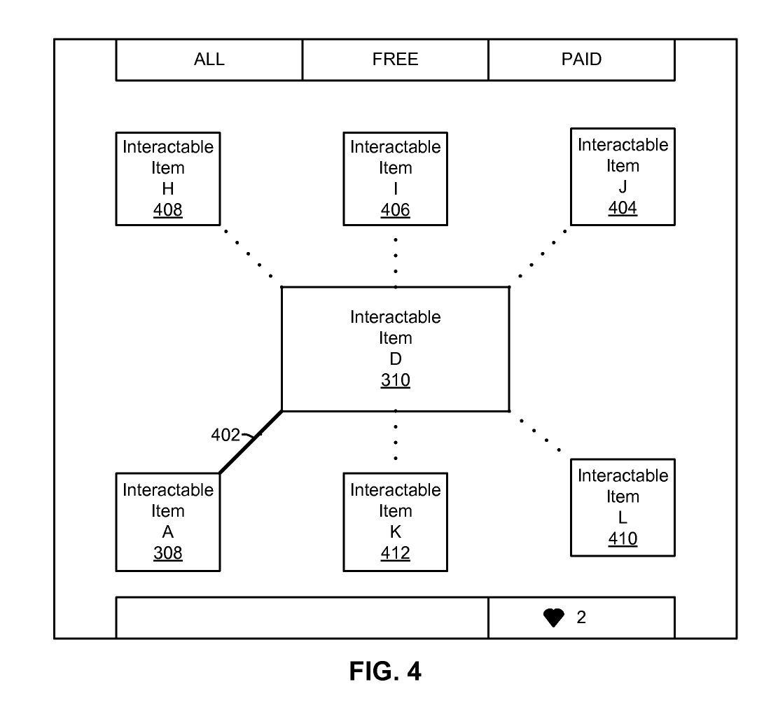

One aspect described herein relates to a breadcrumb trail used to graphically show the user's previous selections. As shown in FIG. 4, interactable item D 310 is now shown in the center of six related interactable items. A solid line 402 is shown connecting interactable item D 310 to interactable item A 308, which was the center item in FIG. 3. Solid line 402 indicates that a user selected interactable item D 310 when presented with main user interface 300 (FIG. 3) associated with interactable item A 308. While solid lines are depicted in FIG. 4, any type of visual indicator different than that used to connect the recommended items may be used to represent the breadcrumb trail. In this aspect, solid line 402 represents the breadcrumb trail from interactable item A 308 to interactable item D 310. The remaining interactable items 404-412 shown have been determined by interactable item recommendation engine 30 to be related to interactable item D 310.

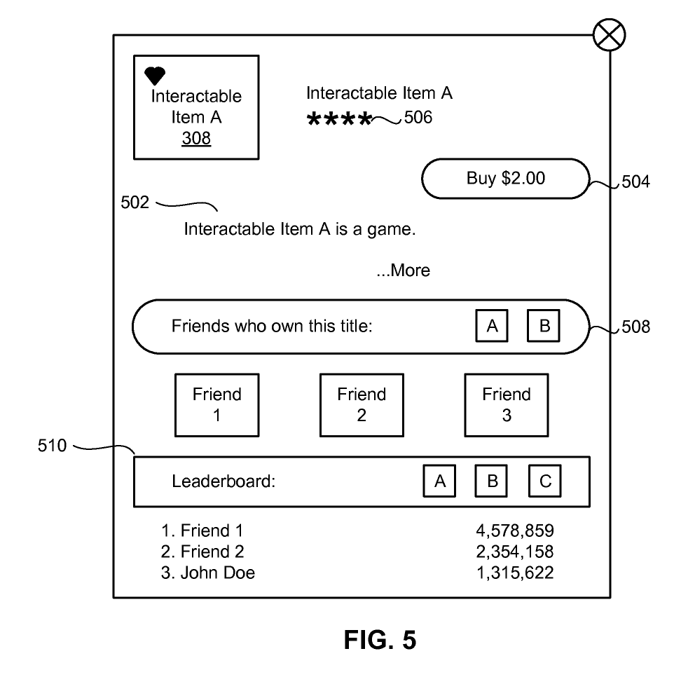

Full details for any item may be presented by selecting an interactable item. For example, a user may double click, single click, right-click, etc., on any interactable item icon to view its full details. As described above, wireless device 102 may be a portable electronic device having touch screen capabilities. Accordingly, a user may view details for an item using various gestures, such as, for example, dragging and pinching. The details may be displayed, for example, in a user-interface overlaying the previous screen that the user was viewing. This is depicted in FIG. 5, wherein a user has chosen to view full details associated with interactable item A 308. The details may include, for example, a description of the interactable item 502, the cost 504, and a rating 506 associated with the interactable item. The details may also include social network data 508, for example, how many, if any, of a user's friends have downloaded the interactable item. The social network data may be drawn from any social networking site. For interactable items such as games, the details screen may also include a leaderboard 510 showing your friends' scores for the selected game. In some aspects, the leaderboard 510 can be configured to show scores for all users within your local geographic area. Social network data, including, for example, leaderboard scores may be compared across a variety of devices. For example, a game may exist for a variety of devices. Scores may be compared for users accessing the game via any or all supported devices.

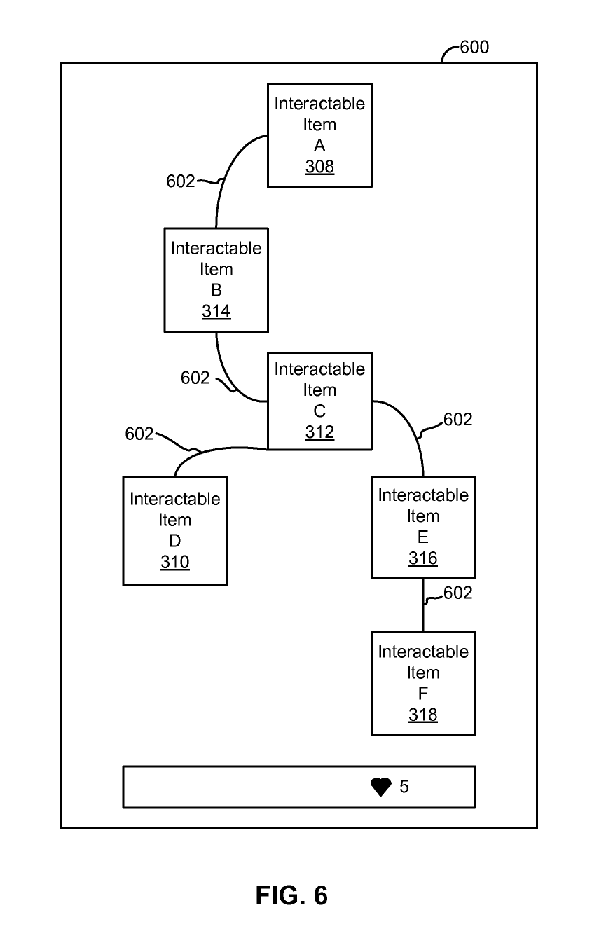

FIG. 6 depicts an example of a breadcrumb trail view 600. The path 602 between items viewed by the user is shown. In this example, the user viewed interactable item A 308, then interactable item B 314, followed by interactable item C 312. The user then viewed interactable item D 310, returned to interactable item C 312, and then viewed interactable items E 316 and F 318.

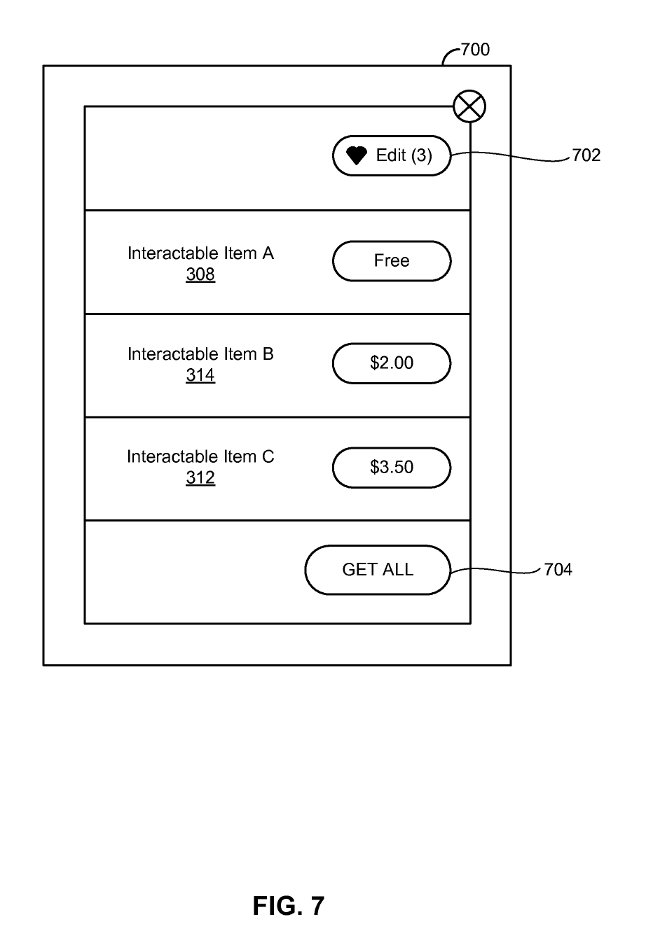

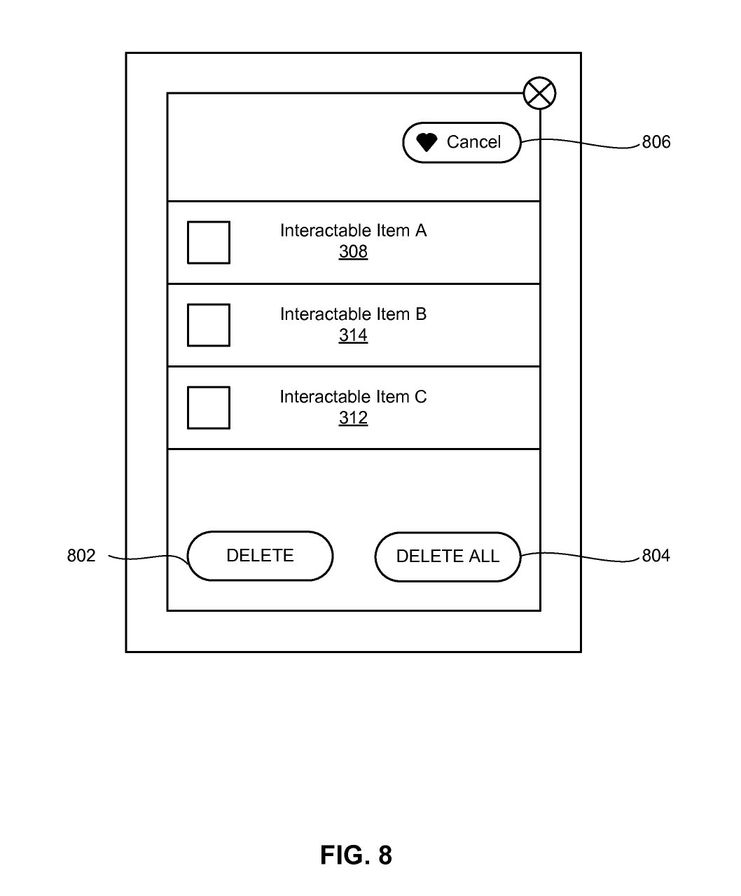

FIG. 7 is an example of a favorites list 700. On this screen the user is shown a list of items the user has added to the favorites list 700. The user is also presented with options for managing the list 700. For example, the user can choose an edit button 702 to remove items from the list, or can choose a download all button 704 to download each item in the list all at once. If the user chooses the edit button 702, the user may be presented with the management screen depicted in FIG. 8. This screen presents the user with the option to delete individual items 802 or all items 804. The user can also select a cancel option 806 to return to the previous screen.

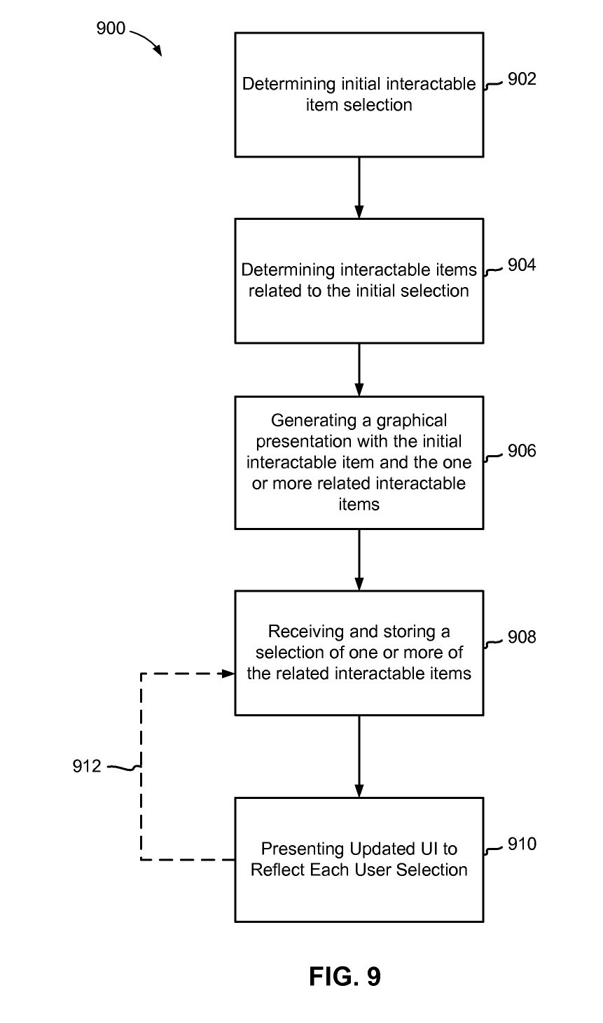

Referring now to FIG. 9, a method 900 for generating interactable item recommendations in accordance with an aspect includes, at 902, determining an initial interactable item selection. For example, the initial interactable item determination may include, but is not limited to, an initial seed interactable item which may form the basis for recommending additional interactable items that may have one or more relationships with the initial seed interactable item. In an aspect, the seed interactable item may be selected by the server based, for example, on a user's previous downloads, a user's social network friends download history, etc. For example, the seed interactable item may be a game application that the user frequently plays on the user's wireless device. In another aspect, the seed interactable item may be selected as an editorial choice for marketing reasons and/or chosen by the owners of a content provider, such as an application store where users can purchase and/or download applications. For example, a content provider may want to promote a new game application. Thus, when a user connects to the content provider's application store, the content provider may set the initial seed interactable item to the new game application the content provider is promoting. In another aspect, a service provider may want to promote a new service provided by the service provider. Thus, when a user connects to the application store, the service provider may set the initial seed interactable item to the new service the service provider is promoting. Other factors may also be considered in determining the seed item selection.

At 904, the method may also include determining interactable items related to the initial selection. As discussed above, a relationship function may be applied to determine one or more interactable items that may have a relationship to the initial selection. A relationship may be based upon finding a correlation or match between data from various data sources, for example, on metadata input by an interactable item's developer, downloads performed by others (e.g., whether multiple users have downloaded a common group of interactable items), social network data, genre data, and/or location data, among other data sources. Thus, an eclectic group of related interactable items may be generated based upon the one or more data sources being used for the relationship.

In an optional aspect, relative weights may be applied to the one or more data sources for determining whether interactable items should be recommended to a user. More weight may be given, for example, to interactable items downloaded by a user's social network friends and/or contacts relative to interactable items downloaded by a general user. For example, because of the relative weighting, an interactable item downloaded by one of a user's social network friends may have the same ranking as an interactable item that has been downloaded by 100 general users.

At 906, the method may include generating graphical representation data with the initial interactable item and one or more related interactable items. The graphical representation data may represent the initial interactable item linked to the one or more related interactable items connecting the initial interactable item with each of the one or more related interactable items. The graphical representation data may be transmitted, for example, to a wireless device and may represent a view to be presented on the wireless device.

Next, at 908, the method may include receiving a selection of the one or more related interactable items and storing the selection. In an aspect, a user may provide a user input to a user interface, e.g. to select to view details one of the related interactable items in the graphical representation. The details may be displayed, for example, in a user-interface overlaying the previous screen that the user was viewing. The details may include, for example, a description of the interactable item, the cost, and a rating associated with the interactable item. The details may also include social network data, for example, how many, if any, of a user's friends have downloaded the interactable item.

At 910, the method may include generating a new graphical presentation with the selected interactable item and one or more related interactable items. The recommendation process described above may be applied and the method may include determining one or more interactable items with a relationship to the selected interactable item.

At 912, the method may optionally return to 908 and receive a new selection of the one or more related interactable items and generate a new graphical presentation with the selected interactable items 910.

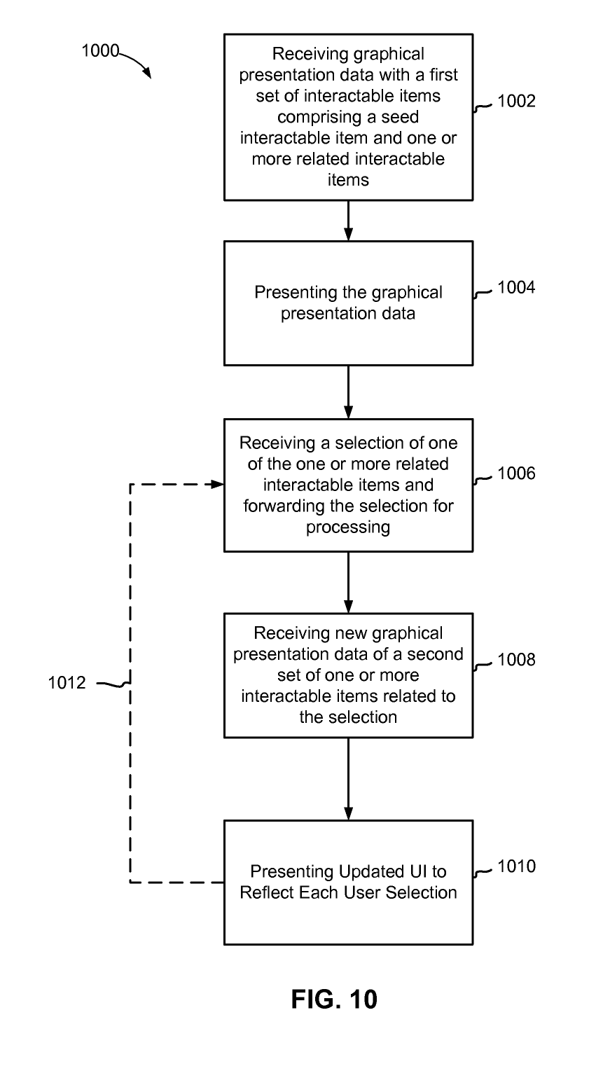

Referring now to FIG. 10, a method 1000 for presenting interactable item recommendations in accordance with an aspect includes, at 1002, receiving graphical presentation data with a first set of interactable items comprising a seed interactable item and one or more related interactable items. For example, a receiver at a wireless device may receive a transmission with the graphical presentation data. In an aspect, the seed interactable item may be selected based upon a user's previous downloads, a user's social network friends download history. In another aspect, the seed interactable item may be selected as an editorial choice for marketing reasons and/or chosen by the owners of a content provider, such as an application store where users can purchase and/or download applications.

At 1004, the method may include presenting the graphical presentation data. For example, a processor on the wireless device may generate an image with the graphical presentation data for presentation on a user interface of the wireless device. In one example, the presentation may include the initial interactable item in the middle of the graphical representation surrounded by the one or more related interactable items. In addition, the graphical representation may include a link, such as a line and/or a path, connecting the initial interactable item with each of the one or more related interactable items.

At 1006, the method may further include receiving a selection of one of the one or more related interactable items and forwarding the selection for processing. In an aspect, a user may provide a user input to a user interface, e.g. to select to view details one of the related interactable items in the graphical representation. The details may be displayed, for example, in a user-interface overlaying the previous screen that the user was viewing. The details may include, for example, a description of the interactable item, the cost, and a rating associated with the interactable item. The details may also include social network data, for example, how many, if any, of a user's friends have downloaded the interactable item.

Next, at 1008, receiving new graphical presentation data of a second set of one or more interactable items related to the selection. For example, the receiver at the wireless device may receive another transmission with the new graphical presentation data. By selecting a new interactable item and generating another graphical presentation for the newly selected interactable item, a new branch in the trail connecting the previously viewed interactable items may be created. In an aspect, a user may review the map with the continuous trail through the previously viewed interactable items from a high level and determine whether to continue a journey through the recommended interactable items in a different direction by selecting an interactable item along the trail and/or whether to continue the journey in the same direction by following the path the user is currently on.

At 1010, the method may include presenting the new graphical presentation, for example, in an updated user interface (UI) to reflect each user selection. For example, the processor on the wireless device may generate an image with the updated UI to reflect the new graphical presentation and each user selection. The new graphical presentation may include the selected interactable item surrounded by the one or more interactable items that are determined to be related to the selected interactable item. The new graphical presentation may also include a link from the selected interactable item to the initial seed interactable item. Thus, the new graphical display may include the previously viewed interactable items, such as the initial seed interactable item, along with the newly selected interactable items and one or more recommended interactable items.

In an aspect, a map may be displayed with a continuous trail that threads through the interactable items selected by a user. Thus, the map may display the user's journey through the previously viewed interactable items, for example, by the continuous trail being highlighted through the previously viewed interactable items. At 1012, the method may optionally return to 1006 for each new user selection.

In one optional aspect, content providers may create custom, predefined breadcrumb trails connecting and/or linking one or more recommended interactable items together. Content providers may use the custom breadcrumb trail for marketing and promotional purposes. For example, the content provider may create a custom breadcrumb trail to promote a new movie being released which may allow users to journey through related interactable items to the new movie. The breadcrumb trail may include, for example, music, games, videos, and/or electronic books that are related to the new movie linked together in the breadcrumb trail. Thus, a user may explore the breadcrumb trail and determine whether to purchase the one or more interactable items related to the new movie.

In another variation, users can publish a breadcrumb trail with recommended interactable items for other users to view and/or journey through. For example, a famous individual may publish a breadcrumb trail with recommended interactable items so that other individuals may journey through the famous' individuals selections and/or choices of interactable items. In another example, users may publish breadcrumb trails with recommended interactable items for other friends to view.

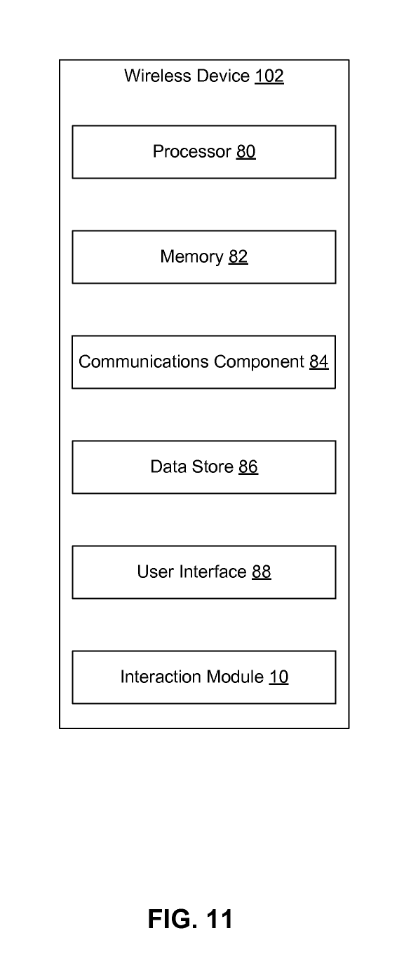

Referring now to FIG. 11, illustrated is an example wireless device 102 operable within the connectivity system in accordance with an aspect. In one aspect, wireless device 102 may include a processor 80 for carrying out processing functions associated with one or more of components and functions described herein. Processor 80 can include a single or multiple set of processors or multi-core processors. Moreover, processor 80 can be implemented as an integrated processing system and/or a distributed processing system.

Wireless device 102 may further includes a memory 82, such as for storing local versions of applications being executed by processor 80. Memory 82 can include a type of memory usable by a computer, such as random access memory (RAM), read only memory (ROM), tapes, magnetic discs, optical discs, volatile memory, non-volatile memory, and any combination thereof.

Further, wireless device 102 includes a communications component 84 that provides for establishing and maintaining communications with one or more parties utilizing hardware, software, and services as described herein. Communications component 84 may carry communications between components on wireless device 102, as well as between wireless device 102 and external devices, such as devices located across a communications network and/or devices serially or locally connected to wireless device 102. For example, communications component 84 may include one or more buses, and may further include transmit chain components and receive chain components associated with a transmitter and receiver, respectively, operable for interfacing with external devices.

Additionally, wireless device 102 may further include a data store 86, which can be any suitable combination of hardware and/or software, that provides for mass storage of information, databases, and programs employed in connection with aspects described herein. For example, data store 86 may be a data repository for applications not currently being executed by processor 80.

Wireless device 102 may additionally include a user interface component 88 operable to receive inputs from a user of wireless device 102 and further operable to generate outputs for presentation to the user. User interface component 88 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 88 may include one or more output devices, including but not limited to a display, a speaker, a haptic feedback mechanism, a printer, any other mechanism capable of presenting an output to a user, or any combination thereof.

Wireless device 102 may also include an interaction module 10 operable to facilitate collection of user data and forward the collected user data for use in recommending interactable items. Wireless device 102 may further include a presenting component 24 operable to display recommended interactable items in a data trail. In an aspect, interface component 88 may transmit and/or receive messages corresponding to the operation of interaction module 10 and presenting component 24, such recommended data trail 26. In addition, processor 80 executes interaction module 10 and presenting component 24, and memory 82 may store them.

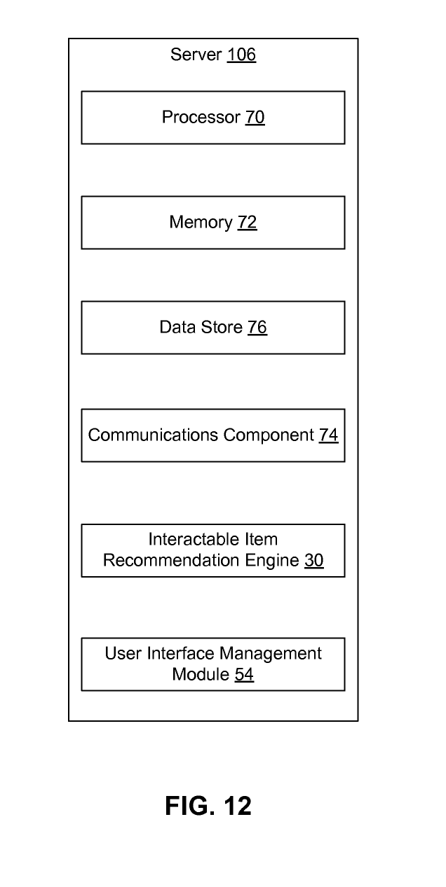

Referring now to FIG. 12, illustrated is an example server device 706 operable within the connectivity system in accordance with yet another aspect. Server 106 manages network connectivity matters for access network 704. Server 106 includes processor component 70 for carrying out processing functions associated with one or more of components and functions described herein. Processor component 70 can include a single or multiple set of processors or multi-core processors. Moreover, processing component 70 can be implemented as an integrated processing system and/or a distributed processing system.

Server 106 further includes a memory 72, such as for storing local versions of applications being executed by processor component 70. Memory 72 can include random access memory (RAM), read only memory (ROM), and a combination thereof.

Further, server 106 includes a communications component 74 that provides for establishing and maintaining communications with one or more parties utilizing hardware, software, and services as described herein. Communications component 74 may carry communications between components on server 106, as well as between server 106 and external devices, such as devices located across a communications network and/or devices serially or locally connected to server 106.

Additionally, server 106 may further include a data store 76, which can be any suitable combination of hardware and/or software, that provides for mass storage of information, databases, and programs employed in connection with aspects described herein. For example, data store 76 may be a data repository for applications not currently executing. Server 106 may also include interactable item recommendation engine 30 operable to recommend one or more interactable items. In addition, server 106 may include a user interface management module 54 operable to generate a plurality of user interface screens that are presented to a user with the one or more recommended interactable items. In an aspect, communications component 74 may transmit and/or receive messages corresponding to the operation of interactable item recommendation engine 30 and user interface management module 54. In addition, processor 70 may execute interactable item recommendation engine 30 and user interface management module 54, and memory 72 may store them.

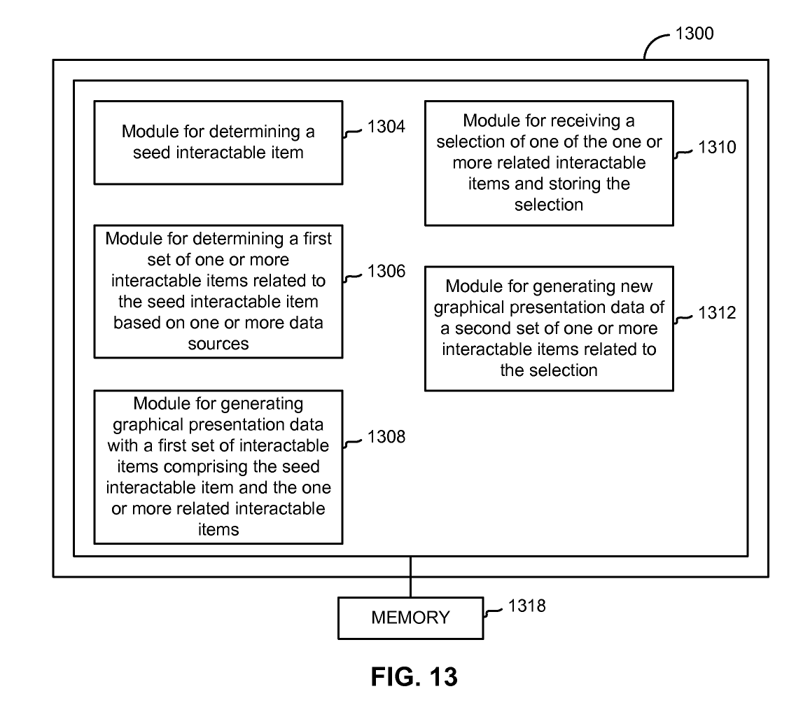

Referring now to FIG. 13, illustrated is an exemplary system 1300 for generating interactable item recommendations. As depicted, system 1300 includes functional blocks that can represent functions implemented by a processor, software, or combination thereof (e.g., firmware). System 1300 includes a logical grouping 1302 of electrical components that act in conjunction. System 1300 may be implemented, for example, by a server.

Logical grouping 1302 can include a module 1304 for determining a seed interactable item. Moreover, logical grouping 1302 can include a module 1306 for determining a first set of one or more items related to the seed item based on a plurality of data sources. Logical group 1302 may further include a module 1308 for graphically presenting the seed interactable item and the one or more related items, a module 1310 for receiving a selection of one of the one or more related items and storing the selection, and a module 1312 for generating a new graphical presentation of a second set of one or more items related to the selection. Additionally, system 1300 can include a memory 1318 that retains instructions for executing functions associated with electrical components 1304-1312. While shown as being external to memory 1318, it is to be understood that electrical components 1304-1312 can exist within memory 1318.

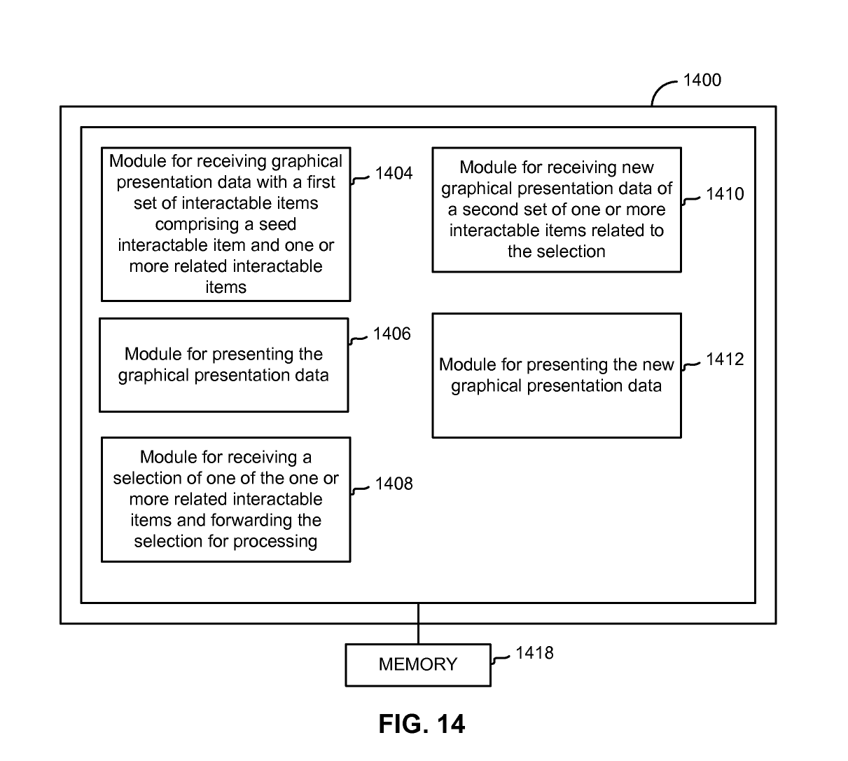

Referring now to FIG. 14, illustrated is an exemplary system 1400 for presenting interactable item recommendations. As depicted, system 1400 includes functional blocks that can represent functions implemented by a processor, software, or combination thereof (e.g., firmware). System 1400 includes a logical grouping 1402 of electrical components that act in conjunction. System 1400 may be implemented, for example, by a wireless device.

Logical grouping 1402 can include a module 1404 for receiving, at a wireless device, graphical presentation data with a first set of interactable items comprising a seed interactable item and one or more related interactable items. Moreover, logical grouping 1402 can include a module 1406 for presenting the graphical presentation data. Logical group 1402 may further include a module 1408 for receiving a selection of one of the one or more related interactable items and forwarding the selection for processing, a module 1410 for receiving new graphical presentation data of a second set of one or more interactable items related to the selection, and a module 1412 for presenting the new graphical presentation data. Additionally, system 1400 can include a memory 1418 that retains instructions for executing functions associated with electrical components 1404-1412. While shown as being external to memory 1418, it is to be understood that electrical components 1404-1412 can exist within memory 1418.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95, and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE, and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs usually reproduce data optically with lasers. Combinations of the above should also be included within the scope of computer-readable media.

While the foregoing disclosure discusses illustrative aspects and/or implementations, it should be noted that various changes and modifications could be made herein without departing from the scope of the described aspects and/or implementations as defined by the appended claims. Furthermore, although elements of the described aspects and/or implementations may be described or claimed in the singular, the plural is contemplated unless limitation to the singular is explicitly stated. Additionally, all or a portion of any aspect and/or implementation may be utilized with all or a portion of any other aspect and/or implementation, unless stated otherwise.

What is claimed is:

1. A method for providing interactable item suggestions, comprising:
determining a seed interactable item;
determining one or more interactable items related to the seed interactable item based on one or more data sources;
generating graphical presentation data comprising a first set of the one or more interactable items and the seed interactable item;
receiving a selection of one interactable item from the first set and storing the selection; and
generating new graphical presentation data comprising a second set of at least one interactable item related to the selection, wherein the new graphical presentation data includes a link from the seed interactable item to the selection.

2. The method of claim 1, wherein determining the one or more interactable items further comprises:
calculating a relationship between the one or more interactable items and the seed interactable item;
linking the one or more interactable items with the relationship to the seed interactable item; and
generating the one or more interactable items linked to the seed interactable item.

3. The method of claim 2, further comprising:
applying a weight to the one or more interactable items; and
selecting the one or more interactable items for generation based upon the applied weight.

4. The method of claim 1, wherein determining the seed interactable item is based upon a history of previous selections of interactable items.

5. The method of claim 4, wherein the history of the previous selections comprises one or more of a download, a purchase, an access, a view, or a share.

6. The method of claim 1, wherein the one or more data sources comprises at least one of a social network account or metadata associated with the interactable item.

7. The method of claim 1, wherein the one or more interactable items are dynamically generated.

8. The method of claim 1, wherein the graphical presentation data is preset by a content provider.

9. The method of claim 1, further comprising:
filtering the first set of the one or more interactable items, wherein the filtering comprises at least one of a regional filter, a price filter, a genre filter, a rating filter, or a content type filter.

10. At least one processor configured to present interactable item suggestions, comprising:
a first module for determining a seed interactable item;
a second module for determining one or more interactable items related to the seed interactable item based on one or more data sources;
a third module for generating graphical presentation data comprising a first set of the one or more interactable items and the seed interactable item;
a fourth module for receiving a selection of one interactable item from the first set and storing the selection; and
a fifth module for generating new graphical presentation data comprising a second set of at least one interactable item related to the selection,
wherein the new graphical presentation includes a link from the seed interactable item to the selection.

11. A computer program product, comprising:
a computer-readable medium comprising:
at least one instruction for causing a computer to determine a seed interactable item;
at least one instruction for causing the computer to determine one or more interactable items related to the seed interactable item based on one or more data sources;
at least one instruction for causing the computer to generate graphical presentation data comprising a first set of the one or more interactable items and the seed interactable item;
at least one instruction for causing the computer to receive a selection of one interactable item from the first set and storing the selection; and
at least one instruction for causing the computer to generate new graphical presentation data comprising a second set of at least one interactable item related to the selection,
wherein the new graphical presentation includes a link from the seed interactable item to the selection.

12. An apparatus, comprising:
means for determining a seed interactable item;
means for determining one or more interactable items related to the seed interactable item based on one or more data sources;
means for generating graphical presentation data comprising a first set of the one or more interactable items and the seed interactable item;
means for receiving a selection of one interactable item from the first set and storing the selection; and
means for generating new graphical presentation data comprising a second set of at least one interactable item related to the selection,
wherein the new graphical presentation includes a link from the seed interactable item to the selection.

13. An apparatus, comprising:
a interactable item recommendation engine configured to determine a seed interactable item and determine one or more interactable items related to the seed interactable item based on one or more data sources; and
a user interface management module configured to generate graphical presentation data comprising a first set of the one or more interactable items and the seed interactable item, receive a selection of one interactable item from the first set and store the selection, and generate new graphical presentation data comprising a second set of at least one interactable item related to the selection,
wherein the interactable item recommendation engine is further configured to determine the second set, and
wherein the new graphical presentation includes a link from the seed interactable item to the selection.

14. The apparatus of claim 13, wherein the interactable item recommendation engine further comprises:
a calculator component configured to calculate a relationship between the one or more interactable items and the seed interactable item;
a linking component configured to link the one or more interactable items with the relationship to the seed interactable item; and
a generating component configured to generate the one or more interactable items linked to the seed interactable item.

15. The apparatus of claim 14, wherein the generating component is further configured to apply a weight to the one or more interactable items; and select the one or more interactable items for generation based upon the applied weight.

16. The apparatus of claim 13, wherein the interactable item recommendation engine is configure to determine the seed interactable item based upon a history of previous selections of interactable items.

17. The apparatus of claim 13, wherein the history of the previous selections comprises one or more of a download, a purchase, an access, a view, or a share.

18. The apparatus of claim 13, wherein the one or more data sources comprises at least one of a social network account or metadata associated with the interactable item.

19. The apparatus of claim 13, wherein the interactable item recommendation engine is further configured to dynamically generate the one or more interactable items.

20. The apparatus of claim 13, wherein the user interface management module is configured to receive a preset graphical presentation by a content provider.

21. The apparatus of claim 13, wherein the user interface management module is further configured to filter the first set of the one or more interactable items, wherein the filter comprises at least one of a regional filter, a price filter, a genre filter, a rating filter, or a content type filter.

22. A method for presenting interactable item suggestions, comprising:
receiving, at a wireless device, graphical presentation data comprising a first set of interactable items comprising a seed interactable item and one or more interactable items related to the seed interactable item, wherein the seed interactable item is determined based upon user data associated with the wireless device;
presenting the graphical presentation data;
receiving a selection of one interactable item from the first set and forwarding the selection for processing;
receiving new graphical presentation data comprising a second set of at least one interactable item related to the selection; and
presenting the new graphical presentation data,
wherein the new graphical presentation data includes a link from the seed interactable item to the selection.

23. The method of claim 22, further comprising:
receiving input requesting a view of all previously viewed interactable items; and
presenting a map of the previously viewed interactable items, the map indicating an order in which the previously viewed interactable items were viewed.

24. The method of claim 23, wherein the map displays a trail linking all of the previously viewed interactable items.

25. The method of claim 24, further comprising:
receiving a selection along the trail for one of the previously viewed interactable items; and
presenting the selected one of the previously viewed interactable items along with a received third set of at least one interactable item related to the selected one of the previously viewed interactable items.

26. The method of claim 24, further comprising:
receiving input to share the trail linking all of the previously viewed interactable items with one or more users; and
sharing the trail with one or more users.

27. The method of claim 22, further comprises presenting one or more scores for one or more interactable items of the first set or the second set.

28. At least one processor configured to present interactable item suggestions, comprising:
a first module for receiving, at a wireless device, graphical presentation data comprising a first set of interactable items comprising a seed interactable item and one or more interactable items related to the seed interactable item, wherein the seed interactable item is determined based upon user data associated with the wireless device;
a second module for presenting the graphical presentation data;
a third module for receiving a selection of one interactable item from the first set and forwarding the selection for processing;
a further module for receiving new graphical presentation data comprising a second set of at least one interactable item related to the selection; and
a fifth module for presenting the new graphical presentation data,
wherein the new graphical presentation data includes a link from the seed interactable item to the selection.

29. A computer program product, comprising:
a computer-readable medium comprising:
at least one instruction for causing a computer to receive, at a wireless device, graphical presentation data comprising a first set of interactable items comprising a seed interactable item and one or more interactable items related to the seed interactable item, wherein the seed interactable item is determined based upon user data associated with the wireless device;
at least one instruction for causing the computer to present the graphical presentation data;
at least one instruction for causing the computer to receive a selection of one interactable item from the first set and forwarding the selection for processing;
at least one instruction for causing the computer to receive new graphical presentation data comprising a second set of at least one interactable item related to the selection; and
at least one instruction for causing the computer to present the new graphical presentation data,
wherein the new graphical presentation data includes a link from the seed interactable item to the selection.

30. An apparatus, comprising:
means for receiving, at a wireless device, graphical presentation data comprising a first set of interactable items comprising a seed interactable item and one or more interactable items related to the seed interactable item, wherein the seed interactable item is determined based upon user data associated with the wireless device;
means for presenting the graphical presentation data;
means for receiving a selection of one interactable item from the first set and forwarding the selection for processing;
means for receiving new graphical presentation data comprising a second set of at least one interactable item related to the selection; and
means for presenting the new graphical presentation data,
wherein the new graphical presentation data includes a link from the seed interactable item to the selection.

31. A wireless device for presenting interactable item suggestions, comprising:
a presenting component configured to receive graphical presentation data comprising a first set of interactable items comprising a seed interactable item and one or more interactable items related to the seed interactable item, wherein the seed interactable item is determined based upon user data associated with the wireless device; and presenting the graphical presentation data;
a navigation component configured to receive a selection of one interactable item from the first set and forward the selection for processing;
the presenting component being further configured to receive new graphical presentation data comprising a second set of at least one interactable item related to the selection; and present the new graphical presentation data,
wherein the new graphical presentation data includes a link from the seed interactable item to the selection.

32. The wireless device of claim 31, wherein the presenting component is further configured to receive input requesting a view of all previously viewed interactable items and present a map of the previously viewed interactable items, wherein the map indicates an order in which the previously viewed interactable items were viewed.

33. The wireless device of claim 32, wherein the map displays a trail linking all of the previously viewed interactable items.

34. The wireless device of claim 33, wherein the presenting component is further configured to receive a selection along the trail for one of the previously viewed interactable items and display the selected one of the previously viewed interactable items along with a third set of at least one interactable item related to the selected one of the previously viewed interactable items.

35. The wireless device of claim 33, wherein the presenting component is further configured to receive input to share the trail linking all of the previously viewed interactable items with one or more users.

36. The wireless device of claim 31, wherein the presenting component is further configured to receive and display one or more scores for one or more interactable items of the first set or the second set.
